(19) United States
(12) Patent Application Publication
(10) Pub. No.: US 2012/0296672 A1
(43) Pub. Date: Nov. 22, 2012

(54) SYSTEM AND METHOD FOR MANAGING MOBILE HIE INFORMATION

(76) Inventors: Matthew Jere Bates, Thornton, CO (US); John Loyack, Cary, NC (US); Patrick Noble, Chapel Hill, NC (US)

(21) Appl. No.: 13/112,151

(22) Filed: May 20, 2011

(51) Int. Cl. G06Q 50/24

(52) U.S. Cl. 705/3

(57) ABSTRACT

A method of providing at least an HIE record to a mobile device comprising receiving at least an attribute of an individual; resolving the attribute to the identity of the individual; requesting the individual's HIE record from at least a HIE repository; receiving the HIE record; and transmitting a signal representative of the HIE record is disclosed. Corresponding systems and computer programs are also disclosed.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright © 2010 Thomson Reuters Global Resources.

### TECHNICAL FIELD

This invention relates generally to a system and method for managing and providing mobile Healthcare Information Exchange (HIE) Data to mobile users of the data.

### BACKGROUND

In 2005, during the Hurricane Katrina disaster, the ability to connect the right people with the right information could have saved hundreds of lives, especially for those suffering medical emergencies. Since that time, hundreds of millions in federal stimulus dollars have been funneled into local governments throughout the U.S. to develop statewide health information technology programs and states are rapidly developing HIEs to streamline information sharing and the continuity of patient care. The success of this effort is dependent on computer connectivity and sufficient sharing of information between disparate HIE systems. Since there is no unified HIE system, most of the HIE systems reside in state and regional clusters. This arrangement presents a significant drawback in that much of the gathering and use of this information occurs outside of the hospital. In fact, most of the emergency use of this data will occur in places where wireless/mobile service and connectivity are unreliable.

In theory, HIEs provide the capability to electronically move clinical information among disparate health care information systems in a related group of health care providers while maintaining the meaning of the information being exchanged. The goal of each HIE is to facilitate access to and retrieval of clinical data to provide safer, more timely, efficient, effective, equitable, patient-centered care. HIEs are also useful to public health authorities, such as the Center for Disease Control and the World Health Organization, to assist in analyses of the health of the population.

HIE systems also facilitate the ability of physicians and clinicians to meet high standards of patient care through electronic participation in a patient's continuity of care across multiple health care providers. Secondary benefits to the health care providers comprise reduced expenses associated with duplicate tests, time involved in recovering missing patient information, paper, ink and associated office machinery, manual printing, scanning and faxing of documents, the physical mailing of entire patient charts, and manual phone communication to verify delivery of traditional communications, referrals and test results.

Formal HIE organizations are in relatively early stages of development, emerging to provide both form and function for HIE efforts, both on independent and governmental/regional levels. The latter organizations (often called Regional Health Information Organizations, or RHIOs) are ordinarily geographically-defined entities which develop and manage a set of contractual conventions and terms, arrange for the means of electronic exchange of information, and develop and maintain HIE standards. So far, RHIOs do not create or provide HIEs to their constituents.

State regulations regarding HIEs and HIT (health information technology) are still being defined. Networks are forming, but lack strong connections from state to state. Other initiatives, such as Federal regulations defining “Meaningful Use” as well as the proliferation of state-sponsored HIEs (such as the North Carolina HIE), in addition to fluctuating health care regulations among the states, are leaving users with a varied mix of resources. HIEs and RHIOs continue to struggle to achieve self-sustainability and the vast majority remains tied to Federal, State, or independent grant funding in order to remain operational.

Another drawback of existing HIEs is that they are limited as to the types of information that they can retrieve on any one individual or patient. This issue is compounded during emergencies where an individual's information may be contained in places other than an HIE (e.g., a department of motor vehicles or other public records). Therefore, a need exists to connect disparate HIEs and other regional information sources/providers to emergency responders. There also exists a need to provide physicians and other staff with HIE and other useful information about a given patient when the physician or other staff are unable to access their HIE/HIT systems. There also exists a need to provide the ability to gather additional information from the Emergency Department (ED) or a patient's location and update the HIE record via a mobile network. Further, there exists a need to assist the emergency or first responder with identification of the patient to locate the patient's health records.

### SUMMARY

These enumerated problems and others are addressed in accordance with the teaching of the present invention which provides methods, systems, and programs for accessing receiving and processing HIE records as well as other information related to a patient. Advantageously, the present invention does this securely via a mobile device over a network. Such a system may be implemented in a variety of ways, including one or more computer programs which are storable on a computer readable medium, which may include one or more central servers and which comprise computer logic which is executable on one or more mobile devices. In this way, the present invention enables secure and efficient use of the HIE records as well as other data sources by a number of healthcare personnel in a number of use scenarios.

The present invention also provides a method and system for a care provider such as an Emergency Medical Technician (EMT) or other emergency responder to identify and retrieve HIE records and other pertinent information associated with a patient who may be unable to communicate. The invention also helps gather information from the scene as well as from other individuals or professionals attending to the afflicted individual prior to the arrival of the emergency responder. The invention helps the emergency responder by providing crucial components from the patient's HIE record including pre-existing conditions, medical prosthetics, pharmaceuticals prescribed, existing medical protocols in place, allergies, medical information and related information. A medical protocol outlines the specific treatment options for a defined set of clinical symptoms or laboratory results. This enables the emergency responder to provide the best care in a secure manner based upon the right information. Additionally, the invention assists the emergency responder in detecting, selecting, notifying and preparing the emergency department that is best suited to receive the individual being treated.

The present invention also provides for the ability for physicians or other medical practitioners to perform consultation/collaboration with other medical practitioners where only mobile or wireless connectivity is available. An example of this scenario is when an on-call doctor and doctor who performed past procedures on a newly admitted patient are contacted when the patient is admitted to an emergency room (“ER”). In either case, the doctor would bring up their patient's information on their smart phone or mobile device. The doctor could annotate and make updates to the HIE record via the mobile HIE system. The doctor may also view the most recent labs results via the mobile device to help diagnose the patient. Additionally, the physician could display/discuss/chat with ER staff regarding the patient's problem list. The problem list is defined as a list of a patient's problems that serves as an index to his or her record. Each problem, the date when it was first noted, the treatment, and the desired outcome are added to the list as each problem becomes known. Thus, the problem list provides an ongoing guide for reviewing the health status and planning the care of the patient. The present invention also comprises a method for medical staff to update, view and confer interactively regarding this problem list.

The present invention also provides for automated “push” notification to a primary care provider or physician when a patient associated with that provider/physician is admitted to the hospital or other urgent care provider after certain criteria are met. “Push” notification describes a style of internet-based communication where the request for a given transaction is initiated by the mobile HIE system and sent to a treating doctor's mobile device or another HIE server. It is contrasted with pull technology, where the request for the transmission of information is initiated by the receiver or client. For example, a surgeon may be notified or consulted if a patient who recently underwent a surgical procedure performed by the surgeon is re-admitted with symptoms related to a form of post-operative distress. Other examples of this could comprise notification of people related to the patient or pharmacy staff if a patient is attempting to procure prescriptions outside the parameters of currently prescribed medications or use guidelines. Another example of this notification might also be a paging or alerting messaging to a guardian or parent of a child who is struck ill while at school or on a trip.

Other systems, methods, features, and advantages of the present invention will be apparent to one having ordinary skill in the art upon examination of the following drawings and detailed description. It is intended that all such additional systems, methods, features, and advantages included within this description, be within the scope of the present invention, and be protected by the accompanying claims.

### BRIEF DESCRIPTION OF THE DRAWINGS

FIG. 1 illustrates an example of an operational environment for a HIE network.

FIG. 2 illustrates an example of a mobile HIE system linked to a HIE network system.

FIG. 3 illustrates an example of a mobile device exterior layout.

FIG. 4 illustrates an example of a mobile device's functional capabilities and hardware.

FIG. 5 illustrates an example of an operational flow using the mobile HIE system.

FIG. 6 illustrates an example of a functional flow using the mobile HIE system.

The invention is better understood with reference to the drawings. The components in the drawings are not necessarily to scale, emphasis instead being placed upon clearly illustrating the principles of the present invention. In the drawings, like reference numerals designate like parts.

### DETAILED DESCRIPTION OF EXEMPLARY EMBODIMENTS

The invention will now be described with reference to exemplary embodiments which are provided to assist in an understanding of the teaching of the invention but are not to be construed as limiting the invention in any way except as may be deemed necessary in the light of the appended claims.

### Description of a General HIE Infrastructure

An HIE network 100 is generally described as a Health Information Exchange (HIE). An HIE is defined as a network that follows state or national standards for network-based transmission of healthcare-related data among a group of facilities, health information organizations (HIO) and government entities.

To meet requirements, HIE technology must enable reliable and secure transfer of data among diverse systems and also facilitate access and retrieval of data.

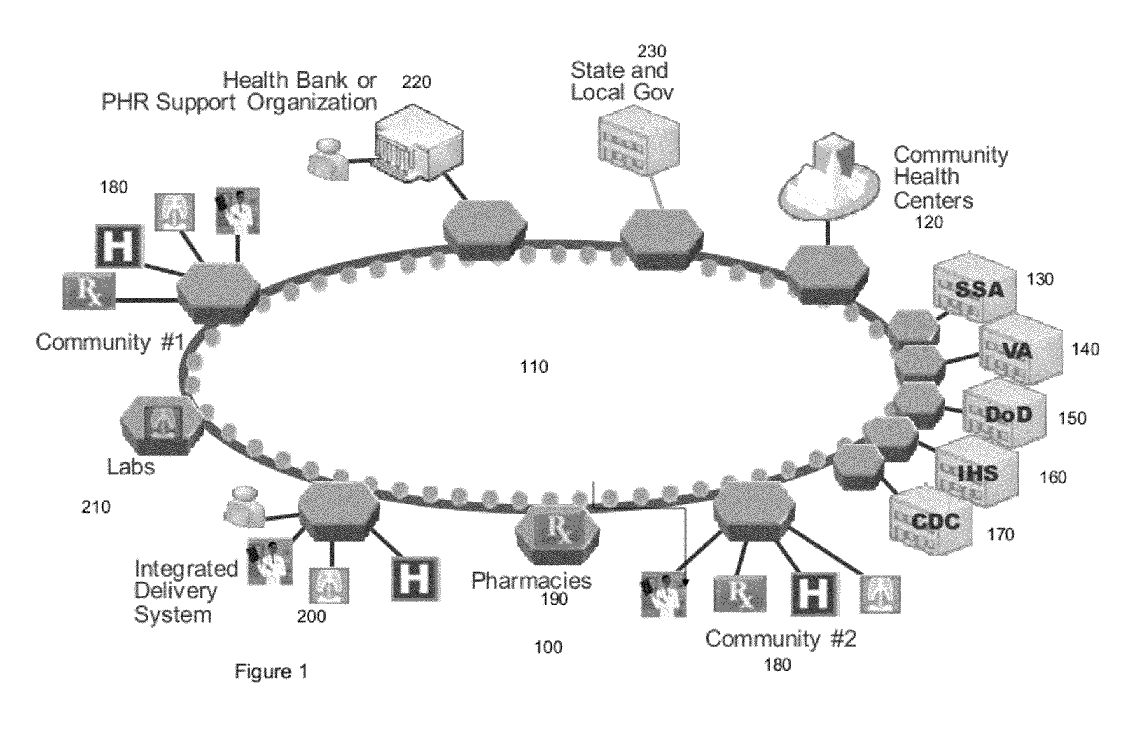

As shown in FIG. 1, an exemplary HIE network 100 may comprise a network of servers 110 that comprise various communities servers 180, their health centers' servers 120, insurance or other organizations' integrated delivery systems' servers 200, state/local/national health information servers 230, pharmacy servers 190, labs servers 210, and various governmental agencies and organizations' servers 220, 130, 140, 150, 160, 170 respectively. Each community server 180 may comprise its own networks of hospitals servers, pharmacy servers, labs servers, and medical staff communities' servers.

An integrated delivery system (IDS) 200 is a network of health care providers and organizations which provides or arranges to provide a coordinated continuum of services to a defined population and is willing to be held clinically and fiscally accountable for the clinical outcomes and health status of the population served. An IDS 200 may own or could be closely aligned with an insurance provider.

Services provided by an IDS 200 can comprise a fully-equipped community and/or tertiary hospital, home health care and hospice services, primary and specialty outpatient care and surgery, social services, rehabilitation, preventive care, health education and financing, usually using a form of managed care. An IDS 200 may also be a training location for health professional students, including physicians, nurses and allied health professionals.

This present invention comprises use of this whole or partial HIE infrastructure where it has been connected to a mobile network and available to authenticated health care staff. The present invention will utilize this infrastructure if networked in this or a similar form. The present invention could also establish links at an appropriate variety of points to retrieve data if the infrastructure is imperfect. The present invention also comprises a “break the glass” scenario where consent may be required by a patient found non-responsive to permit the emergency responder or other medical staff access to the HIE and other records to provide critical or lifesaving care, even though the patient has not provided the normal, requisite consent.

Data privacy and security is critical to any system that transfers personally-identifying medical data. Fortunately, the existing infrastructure of the HIE network (100) will have the necessary security and privacy safeguards built into it. The present invention will be layered over the existing HIE infrastructure, and can leverage the existing security safeguards.

### Description of an Example of a Mobile HIE Mobile Device and Network

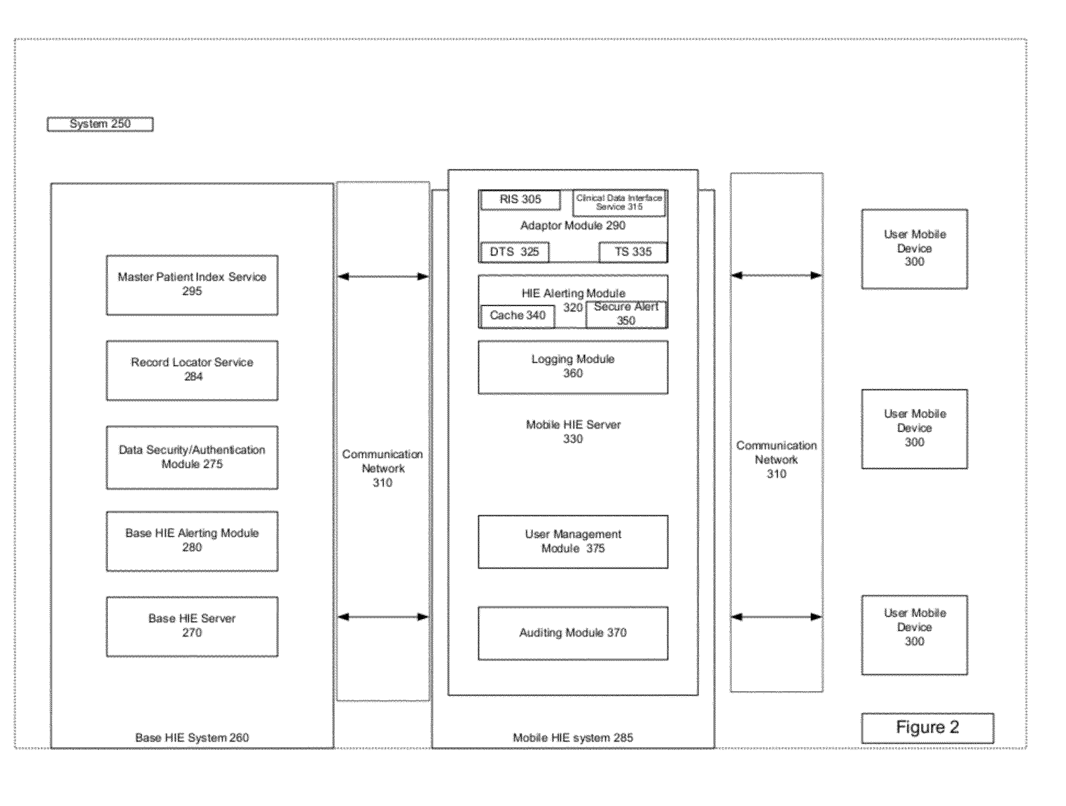

As shown in FIG. 2, a mobile HIE system 250 connects to at least one of the servers in HIE network 100. The invention comprises at least a base HIE system 260 further comprising at least a base HIE server 270 and a base HIE alerting module 280 coupled to a mobile HIE system 285. The mobile HIE system 285 comprises at least an adaptor module 290 which is configured to communicate with one or more remote mobile devices 300 and other HIE systems 260 over a communication network 310. The base HIE system 260 may also comprise data security/authentication modules 275. The communication network 310 is typically a wireless network providing data transfer protocols such as GPRS or 3G. Other network types may comprise a wireless local area networks (WLAN) connection using IEEE specifications or related types of wireless networks, or communication via wireless radio transmission. The present invention comprises use of network security measures that, at a minimum, comply with U.S. Department of Health and Human Services § 164.312 of the Security Rule section that comprises:

1) authentication of all users;

2) encryption of data;

3) measurement and verification of data integrity;

4) multi-level access control by user;

5) logging and audit controls; and

6) transmission security protocols.

Adaptor module 290 is tailored to each clinical and administrative data source and serves as the “on-ramp” to the central backbone of the HIE system 285. Each adaptor module is composed of a comprehensive stack of data services that enable interoperability and establish data standards throughout the network. Services may comprise a record locator service 284 (RLS) and a master patient index 295 that provides standardized linkage in the HIE system 250. The RLS 284 comprises a search and retrieval function that queries the various HIE servers 110 to locate records related to a particular patient. The master patient index 295 may comprise an index comprising a set of individuals for whom HIE records may also be available. Either service (284,295) facilitates access and location of HIE records. These services may also reside outside of the base HIE system 260. A set of security techniques is implemented to cryptographically hash the aggregated data to prevent access to patient demographic data stored in the centralized master patient index 295. The adaptor module 290 also comprises the record index service 305 that interfaces the base HIE system 260 to the RLS 284 and standardizes and blinds demographic information before sending requests to the RLS 284. The adaptor module 290 comprises a data transfer service 325 that manages adaptor-to-adaptor communication of clinical information. The adaptor module also comprises a clinical data interface service 315(CDIS). The CDIS comprises a set of pluggable drivers for communication with local clinical data sources such as electronic medical records (EMR), lab, or pharmacy servers or systems. The CDIS 315 supports the disparate clinical data sources of each facility. Each driver may run in one or more threads or processes dependent on available hardware and required workload. The adaptor module 290 also comprises a terminology service (TS) 335 that is utilized by the data transfer service 325 and CDIS 315 to provide translation between local and newer standardized nomenclatures of information. The adaptor module 290 also comprises a local data cache to provide storage, if necessary, in which both record location index information and clinical information is cached if a data connection is lost. The local data cache may be a single physical database management server or it may be federated across multiple physical servers.

The base HIE system 260 comprises an alerting module 280 that is coupled with a mobile HIE alerting module 320 coupled to a mobile HIE server 330. The HIE alerting module further comprises a mobile HIE alert cache 340 and a mobile HIE secure alert module 350. The mobile HIE system 285 also comprises logging modules 360, auditing modules 370, and a user management module 375. The logging modules 360 record and identify information that would be helpful for different situations, such as detecting attacks, fraud, and inappropriate usage. The logging module 360 comprises a secure transport mechanism to prevent configuration changes and log alteration. The auditing module 370 performs ongoing monitoring of the system to be in compliance with applicable laws, regulations and policies of rulemaking bodies. The modules allow the periodic or ad hoc execution of audits by those tasked with auditing, as well as provide basic alerting and detection of actions that would violate said laws, regulations, and policies.

The alerting module 320 comprises alerting services that produce public health alerts and reports as well at alerts at an individual patient level. The user management module 375 comprises services that authorize and track various users on the system.

### Description of an Example of a Mobile HIE Mobile Device and its Functions

The mobile devices 300 may comprise such devices as net books, tablets or smart phones such as those manufactured and provided by Google™, Sony Ericsson™, Nokia™, Samsung™, Apple™ or the like. For the sake of convenience, the invention will now be described with regard to an implementation on an iPhone™ device 300, but it will be understood that this is purely exemplary of the type of device 300 that could be used to implement the teaching of the invention. Programming and implementation of an iPhone application using the Apple™ Software Development Toolkit are well documented and may be found at the URL http://developer.apple.com/programs/ios/ or programming books like “IPhone SDK Programming, A Beginner's Guide” James A. Brannan © 2009. The programming book is herein incorporated by reference. Conventional iPhone architecture and programming techniques for programming an iPhone device 300 are well appreciated by those skilled in the art and for the sake of clarity, extensive detail on those steps and components will be omitted from the following description unless comprising a step in the invention.

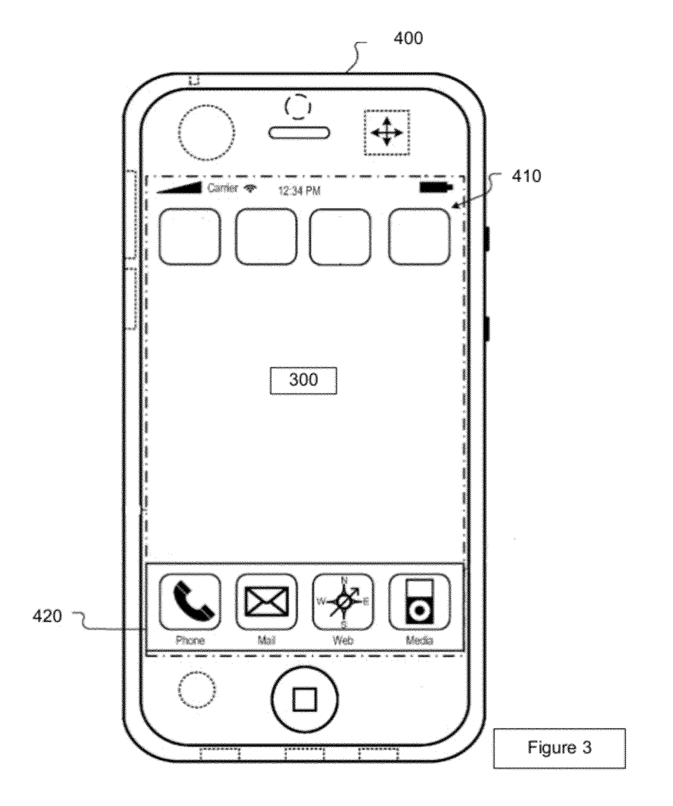

Additionally, as shown in FIG. 3, a typical mobile device 300 which is useful in implementing the teaching of the invention comprises a body or casing 400 which defines the exterior perimeter of the device. A graphical user interface or screen 410 is provided, typically of the dimensions three by five inches. Such screen sizes are suitable for reading extended portions of text. The invention also contemplates larger screens available to devices 300 such as tablets, net books or other portable devices. To enable a user to interface with the device, a touchpad 420 allowing full navigation and input is provided. Depending on the features of the specific mobile device 300, this interface 420 may also comprise a QWERTY keypad in the touchpad 420 or it may be coupled separately, although the present invention is not to be limited to devices having such keypads.

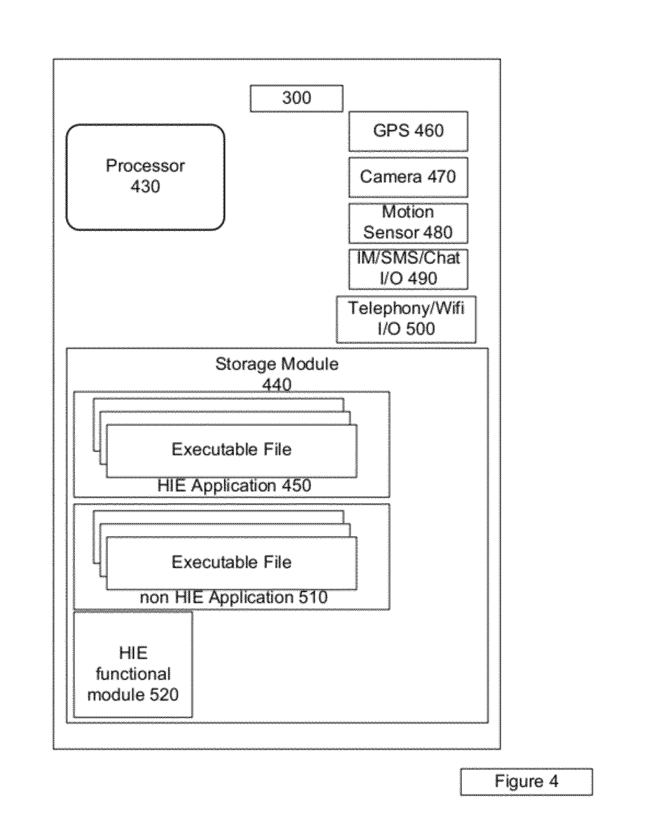

As shown in FIG. 4, the mobile device 300 comprises both a processor 430 which is used to execute computer logic and a storage module 440 on which one or more mobile HIE applications 450 may be stored. Additional features provided in the mobile device 300 may also comprise, without limitation, a GPS module 460, a camera and/or video recorder 470, a motion sensing module 480, and an IM/Chat/SMS I/O interface 490 if separate from the standard mobile device telephony I/O interface 500. The device 300 also may comprise applications 510 unrelated to this invention application(s) 450, which may provide additional data for the invention application. These unrelated applications 510 may comprise standard applications found on device 300, such as calendaring, timing, chat, instant messaging, video or image display, contact management, or other applications that may help a user schedule, collaborate, or communicate with others in the use of this invention.

In accordance with the teaching of the invention, the mobile device 300 is provided with an HIE application 450 which enables the device 300 to interactively run one or more HIE functional modules 520 in contact with Mobile HIE system 285. These functional modules 520 and applications 450 are streamed to the mobile device 300 through an I/O interface 500 of the device 300 with the Mobile HIE server 330. The HIE functional modules 520 may comprise executable code to facilitate the mobile device 300 functions for interaction with the mobile HIE system 285. In order to initially configure the device 300 for use with the present invention it is necessary to first enable an installation of the executable application 450. In the context of an iPhone device 300, the application 450 is a series of computer executable files. As the application 450 is deployed over a mobile data network 310 it is desirable that the physical size of files be kept to a minimum. In the present invention the executable application 450 may also comprise an additional set of executable files to handle encryption and secure data manipulation. The mobile application may also comprise a data cache to hold data in a cached mode prior to acting on it. Correspondingly, the server 330 desirably comprises conventional computer architecture such as memory, processors, I/O devices and the like, as will be well appreciated by those skilled in the art. For the sake of clarity such conventional architecture components will be omitted from the following description.

### An Example of an HIE Mobile Usage Scenario

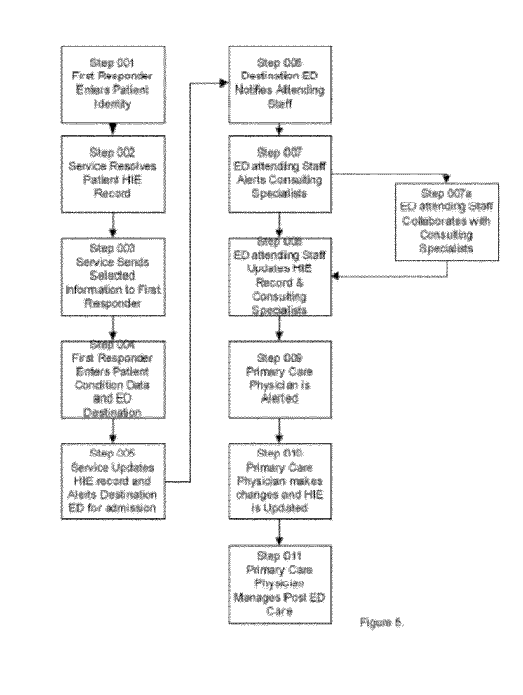

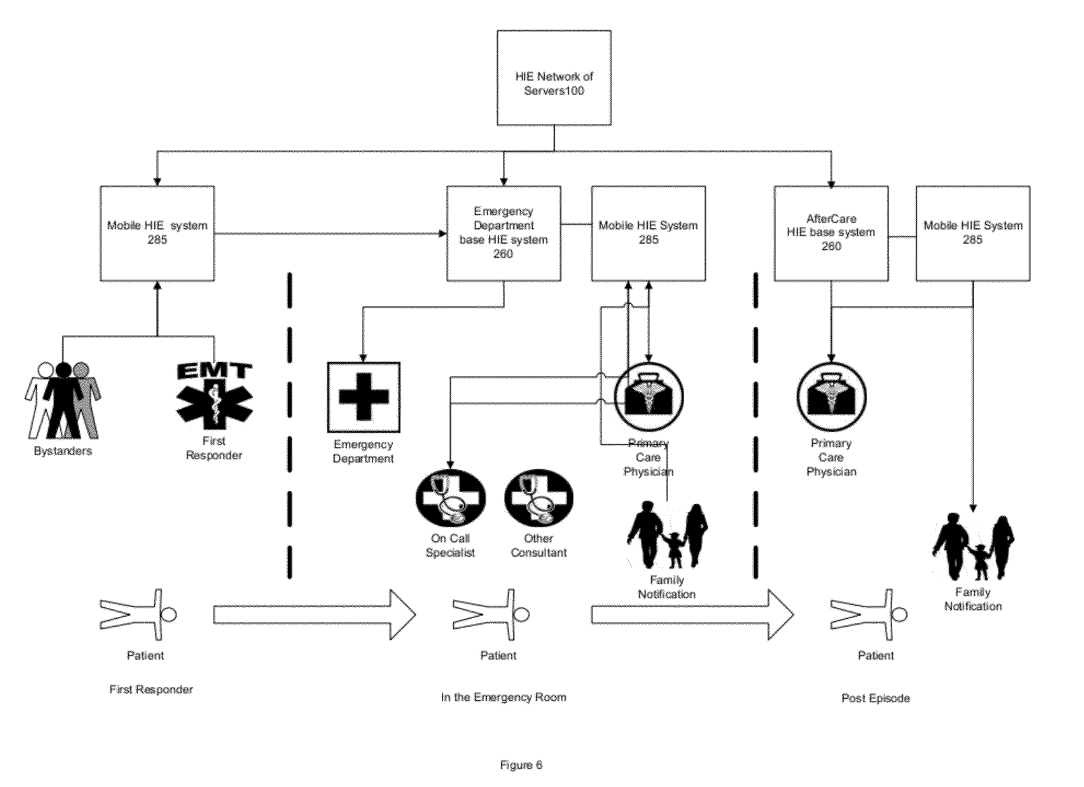

In FIG. 5 and FIG. 6, the mobile HIE system comprises a server 330 coupled via network 310 or some other means of connectivity to at least a single base HIE system 260, preferably to any base HIE system 260 that is available, and the server 330 coupled via a communication network 310 to mobile devices 300 that are uniquely associated with individuals performing services (FIG. 2). The network 310 may comprise a wireless network. Within the server 330 a user management module 375 is provided that resolves the identities of the system users, the organizations that they represent, their respective permissions to the HIE/other information and also has the ability to resolve a patient identified in an emergency to the HIE record associated with that patient. The server 330 also comprises an HIE access point that when queried with the identity of a patient, retrieves the HIE record associated with the patient from one of the coupled base HIE systems 260.

The first responder identifies the patient via the mobile device 300 (Step 001) to the server 330. The first responder enters some attribute of the patient to begin the HIE retrieval process. For this invention, an attribute is defined as any identifying indicia present on the patient, or any identifying documentation carried by the patient or other information that may be gathered from the area or people around the patient's location that would be useful in resolving the identity of the patient. Some examples of indicia would be identifying scars, facial structure, finger prints, dental work, retinal prints, tattoos, piercings, or any other differentiating features of the patient. This identification may be made either by the first responder entering identity criteria or other secondary information, i.e. using driver's license or other identification methods that may be present with the patient. Absent identifying documents, the first responder may utilize the mobile device camera to record visual records that can be transmitted to the Mobile HIE system 285 for identification, (for example, pictures that allow face, dental or fingerprint searches to be sent to the server 330) by the user management module 375. In any case, the patient is identified by entity resolution methodology, and its highest probabilistic matches may be sent to the first responder for selection. Other means of identification may involve witnesses or lay people at the scene and also may comprise identification via 911 emergency calls that forward or connect the call with the emergency responder and other service professionals like the police or the fire department. Still other means of identifying the patient may comprise accessing information from video, photos or other identifying aspects from the patient's mobile device or a bystander's mobile device. Once the resolution of the patient's identity is made, the HIE record related to that patient is retrieved from its respective base HIE system 260. For the purposes of this invention, an HIE record is defined as the information stored in a base HIE system 260 repository that corresponds uniquely to the patient. The present invention also comprises adding or supplementing information to the transmitted HIE record contained in other HIE records corresponding to the patient held in other HIE repositories, public records or other data sources that would help the mobile device 300 user in assisting the patient. Other useful information may be received by the mobile device 300 from more than a single base HIE system 260 or other records databases. The server 330 may also supplement the HIE record data from multiple base HIE systems 260, other public records databases, and other databases that may help fill out the information necessary to identify and treat the patient. The server 330 parses the information retrieved and transmits relevant information about the patient to the first responder (Step 003). The server may parse the HIE record and any supplemental data to provide only the appropriate data required by the specified user (e.g., first responder, ER staff or physician, primary care physician, etc. . . ). The first responder also enters the patient's condition information either interactively or asynchronously via the mobile device 300. The invention also contemplates the first responder entering this data or verbally communicating the data to voice recognition software or another person who enters the data in the server. For the purposes of rapid data entry, the first responder may be inputting the patient's conditions on a largely graphical display of a patient's body or possibly even taking photographs or video of the victim for others to assist in treatment. The adaptor module 290 in the server 330 then parses this new information in preparation for retrieving the information from a base HIE system 260 or sends the information to others who will need it for diagnosis, treatment, or alerting purposes. The present invention also comprises the construction of a reduced information set from the HIE record to be transmitted to the various recipients. For example, an adaptor module 290 may suggest emergency departments (ED) that are proximately located or have special facilities for the type of condition indicated by the incoming patient's condition. The first responder either enters the ED destination or it is selected (Step 004) by the Mobile HIE adaptor module 290. The adaptor module 290 updates a copy of the HIE record and alerts the destination ED by sending all pertinent information to the ED medical information system. (Step 005). Once the patient is in transport to the ED, the adaptor module 290 then transfers control of the HIE record to the receiving ED and their representative HIE record system. The receiving ED takes the HIE record and parses it to identify and alert the ED attending staff in preparation to receive the patient. (Step 006). The Mobile HIE system 285 may take the alerting information and use it to contact the ED attending staff as well as the patient's primary care physician if known. Additionally, if the patient has an advance directive such as a living will or a “do not resuscitate” directive, or any other legal document on file, it can be recovered for the ED to abide by the advance directive instructions. The attending staff pushes the pertinent HIE information to their systems for admission, and alerts Consulting Practitioners (Step 007) to ready the ED for the patient. Once the patient arrives at the destination ED, the ED can receive the patient with its resources marshaled to execute the best care. The ED's systems then take over the primary HIE record with the mobile HIE system 285, receiving updates as necessary. The mobile HIE system 285 may continue to be used even after the patient arrives if the consulting specialist is not in a place where access to a specific hospital's HIT system is easily achieved. Therefore, the mobile HIE system 285 can serve as a consulting or collaboration space, sending or streaming data (including digital and analog instrument readouts), images, annotations, reference material and other information useful to a specialist or the attending staff on the patient in question. In that case, the mobile HIE system 285 continues to update the HIE record at the ED. Once the consultation is complete, the mobile HIE system 285 will finally update the HIE at the ED and then periodically poll the ED record for updates to provide to the consulting specialist or to others that would require updating. See, e.g., (Step 008) and/or Step (009) respectively (.i.e. where the patient's primary care physician, or others that would take over continuing care for the patient.) Preferably, the primary care physician can continue to access the mobile HIE record for a period of time after the care episode. The primary care physician can be alerted if the patient is re-admitted for reasons that would suggest complications from the previous ED/continuing care treatment from the initial care episode. Mobile HIE content may comprise multimedia content, video, audio, textual and other presentation formats.

Any process descriptions or blocks in figures, such as those in the accompanying figures, should be understood as representing modules, segments, steps or portions of code which comprise one or more executable instructions for implementing specific logical functions or steps in the process. Alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such variations and modifications are intended to be included within the scope of this disclosure and the present invention and protected by the following claims.

What is claimed is:

1. A method of providing at least an HIE record comprising:
receiving at least an attribute of an individual;
resolving the attribute to the identity of the individual;
accessing an HIE record of the individual from at least an HIE repository;
receiving the HIE record; and
transmitting a signal associated with the HIE record, the signal adapted to be received by a mobile device.

2. The method of claim 1 wherein receiving an attribute comprises receiving the attribute from at least the mobile device.

3. The method of claim 1 wherein resolving the attribute comprises using a set of secondary information about the individual to resolve the individual's identity.

4. The method of claim 1 further comprising authenticating, prior to the step of transmitting, an intended recipient of the signal.

5. The method of claim 4 wherein authenticating comprises biometric authentication.

6. The method of claim 1 wherein the HIE record further comprises a set of data received from more than one HIE repository.

7. The method of claim 6 wherein the set of data received from more than one HIE repository comprises at least a set of non-HIE data received from at least a non-HIE data source.

8. The method of claim 1 wherein transmitting the signal associated with the HIE record comprises transmitting a signal representative of a reduced set of HIE data to the mobile device.

9. The method of claim 8 wherein the reduced set of HIE data is adapted to be received by a set of multiple mobile devices.

10. The method of claim 9 wherein the set of multiple mobile devices comprises a first mobile device and a second mobile device, the first mobile device and the second mobile device being associated with a first user type and a second user type, respectively, and wherein the reduced set of HIE data adapted to be received by the first mobile device is dependent upon the first user type and the reduced set of HIE data adapted to be received by the second mobile device is dependent upon the second user type.

11. The method of claim 1 further comprising, after the transmitting step, receiving a modified HIE record.

12. The method of claim 11 further comprising updated the HIE repository with the modified HIE record.

13. The method of claim 11 wherein the modified HIE record is forwarded to at least an emergency room server.

14. The method of claim 1 wherein a primary care physician is associated the individual.

15. The method of claim 1 wherein a recipient of the HIE record is a consulting specialist.

16. The method of claim 15 further comprising (a) receiving a first message from a first recipient of the HIE record; (b) receiving a second message from a second recipient of the HIE record; and (c) promoting collaboration by making the first message and the second message accessible to the second recipient and the first recipient, respectively.

17. The method of claim 1 wherein the HIE record has been previously accessed by the mobile device.

18. The method of claim 17 wherein only the part of the HIE record that is different than the previously accessed HIE record is transmitted to the mobile device.

19. A system comprising:
at least one processor;
at least one memory or a computer-readable medium coupled to the processor and operable to store instructions, which, when executed by the processor, causes the processor to:
receive at least an attribute of an individual;
resolve the attribute to the identity of the individual;
access of the individual's HIE record from at least a HIE repository; and
transmit a signal associated with the HIE record, the signal adapted to be received by a mobile device.

20. An article comprising a machine-readable medium storing machine-readable instructions that, when applied to the machine, cause the machine to:
receive at least an attribute of an individual;
resolve the attribute to the identity of the individual;
access the individual's HIE record from at least a HIE repository; and
transmission of a signal associated with the HIE record, the signal adapted to be received by a mobile device.
